(19) United States
(12) Patent Application Publication
(10) Pub. No.: US 2014/0225708 A1
(43) Pub. Date: Aug. 14, 2014

(54) OVERLOAD PROTECTION FOR SHAPE MEMORY ALLOY ACTUATORS

(71) Applicant: GM GLOBAL TECHNOLOGY OPERATIONS LLC, Detroit, MI (US)

(72) Inventor: Patrick B. Usoro, Troy, MI (US)

(73) Assignee: GM GLOBAL TECHNOLOGY OPERATIONS LLC, Detroit, MI (US)

(21) Appl. No.: 13/767,550

(22) Filed: Feb. 14, 2013

(51) Int. Cl. H01H 61/01

(52) U.S. Cl. CPC H01H 61/0107
USPC 337/128

(57) ABSTRACT

An overloading protection system adapted for use with a shape memory alloy actuator, includes at least one shape memory alloy switching element congruently activated with the actuator, and further includes a releasable connector configured to automatically disconnect the actuator from its activation source and/or release a latch, so as to effect a secondary work output path for the actuator, when an overloading condition occurs.

### TECHNICAL FIELD

The present disclosure generally relates to methods and systems for controlling shape memory alloy (SMA) actuators, and more particularly, to methods of and systems for providing overload protection to an SMA actuator utilizing a congruently activated SMA switching element to disconnect a power source and/or release a latch.

### BACKGROUND

Shape memory alloy actuators are activated by heating the SMA material to a temperature that is above its transformation temperature range. This causes the material to undergo phase transformation from the Martensite to the Austenite phase, wherein it contracts and in the process is used to do work. Typically, SMA wires are heated through resistive heating by applying an electrical current through the wire, also known as Joule heating. A concern associated with SMA actuation, however, is overloading (i.e., applying an excess of heat energy above what is required to actuate the wire). Overloading causes longer cooling times, and therefore reduced system response bandwidth, and in some cases may damage the wire. It is therefore desirable to have an effective and robust means of preventing wire overloading.

### SUMMARY

An overloading protection system according to examples of the present disclosure is adapted for use with a shape memory alloy actuator, wherein the actuator is communicatively coupled to an activation source, drivenly coupled to a load, produces a driving force when activated by the source, and presents stationary and working ends. The system includes a shape memory alloy element communicatively coupled to the source and cooperatively configured with the actuator, such that the actuator and element are generally contemporaneously and coextensively activated. A releasable connector interconnects the actuator and element, the actuator, element, and connector being cooperatively configured to: drive the load when the load is less than a threshold and the actuator and element are activated; and disconnect the actuator and element when the load is equal to or greater than the threshold and the actuator and element are activated.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is an elevation of an overloading protection system presenting a circuit, and including a shape memory alloy actuator drivenly coupled to a load, an activation source, a controller, a congruently activated shape memory alloy switching element, and a releasable connector inter-engaging the actuator and element, wherein the connector includes a detent holding mechanism and in enlarged caption view, a rack and pinion latching assembly, in accordance with an example of the present disclosure;

FIG. 1a is an elevation of the system shown in FIG. 1, wherein the actuator and switching element have been activated, and the load translated during normal operation;

FIG. 1b is an elevation of the system shown in FIG. 1, wherein the actuator and switching element have been activated, the load is blocked, and the connector has been caused to open the circuit and produce a secondary work output path for the actuator;

FIG. 2 is an elevation of an overloading protection system presenting a circuit, and including an activation source, a controller, a shape memory alloy actuator drivenly coupled to a load, a shape memory alloy switching element, and further including a releasable connector inter-engaging the actuator and element, and including a common member and an end cap/blocking member latching assembly, in accordance with an example of the present disclosure;

FIG. 2a is an elevation of the system shown in FIG. 2, wherein the actuator and switching element have been activated, the load is blocked, and the connector has been caused to produce a secondary work output path for the actuator by disengaging the member and cap;

FIG. 3 is a partial elevation of an overloading protection system including a latching assembly having a lever and blocking member, in accordance with an example of the present disclosure;

FIG. 3a is an elevation of the system shown in FIG. 3, wherein the actuator and switching element have been activated, the load is blocked, and the connector has been caused to produce a secondary work output path for the actuator by disengaging the member and lever;

FIG. 4 is an elevation of an overloading protection system presenting a circuit, and including an activation source, a controller, a shape memory alloy actuator drivenly coupled to a load, a shape memory alloy switching element, and further including a releasable connector inter-engaging the actuator and element, and including a detent external to the circuit but communicatively coupled to the controller (communicating an open overloading condition to the controller in hidden-line type), in accordance with an example of the present disclosure; and

FIG. 5 is an elevation of an overload protection system including an actuator, switching element, and releasable connector selectively interconnecting the actuator and element, and composing a peripheral circuit, in accordance with an example of the present disclosure.

### DETAILED DESCRIPTION

Various external sensors and/or mechanical devices sensors have been used to alleviate concerns relating to overloading. These provisions, however, may in some instances add to the complexity, costs, and packaging requirements of conventional SMA actuators. For example, a conventional approach to dealing with overloading is to attach a relief spring at one end of the SMA wire, wherein the spring is preloaded to handle the normal operating force without displacement. If the force in the wire exceeds the pre-specified preload value, the spring is stretched/compressed to limit the load on the wire. To ensure that the load on the wire does not get excessive, the spring rate must be low. Unfortunately, this generally requires a high preload and a low spring rate, which results in a relatively bulky spring that significantly increases the overall size of the actuator.

Examples of the present disclosure address these concerns, and recites novel methods of, and systems for providing overloading protection to an SMA actuator utilizing a switching SMA element that is congruently activated with the actuator. Among other things, examples of the present disclosure are useful for enabling the SMA actuator to be employed without exposure to overloading conditions, and as such, for extending the life of the actuator, as well as the mechanisms driven thereby. In Joule heating examples, the present disclosure further provides overheating protection; and in an example provides both overheating and overloading protection by autonomously opening the electric circuit and producing a secondary work output path. More particularly, with respect to the latter, the present disclosure uses a latch, as opposed to a preload spring, to hold the stationary end of the SMA wire in place, thereby significantly reducing the size and rate of the overload relief spring. With this arrangement, the spring rate can be selected such that the load that the SMA wire experiences following the overload condition is much lower than the wire load rating, thereby enhancing the useful life of the wire. Thus, examples of a system according to the present disclosure do not require high precision measurements of voltage and current or expensive electronics and data processing to function; thereby offering a potentially robust, fast and low-cost solution. Also, although the load relief spring is replaced by multiple components, the overall size and potential cost of the overall system is reduced.

In general, the present disclosure concerns an overloading protection system adapted for use with a shape memory alloy actuator. The actuator is communicatively coupled to an activation source, drivenly coupled to a load, produces a driving force when activated by the source, and presents stationary and working ends. The system includes a shape memory alloy switching element communicatively coupled to the source and cooperatively configured with the actuator, such that the actuator and element are congruently (i.e., generally contemporaneously and coextensively) activated. The system further includes a releasable connector interconnecting the actuator and element. The actuator, element, and connector are cooperatively configured to drive the load when the load is less than a threshold value and the actuator and element are activated, and disconnect the actuator and element when the load is equal to or greater than the threshold and the actuator and element are activated. The switching element may be redundant, wherein it does not provide useful mechanical work during normal operation.

As described and illustrated herein, an example of a novel overloading protection system 10 is adapted for use with a shape memory alloy (SMA) actuator (e.g., wire) 12; however, it is certainly within the ambit of the present disclosure to utilize the benefits of the system 10 with other active material actuation susceptible to overloading, and in other applications and configurations as discernable by those of ordinary skill in the art. In an example, the system 10 utilizes the shape memory effect of a switching element (e.g., SMA wire) 14 to interrupt the activation signal of and/or effect a secondary work output path for an actuator 12. Examples of the present disclosure may be applied wherever active material actuators, and more particularly shape memory alloy wire is employed and overloading is of concern. In an automotive setting, for example, the present disclosure may be used to selectively deactivate or produce a secondary work output path for an external intake valve susceptible to being blocked by snow, dirt, or ice.

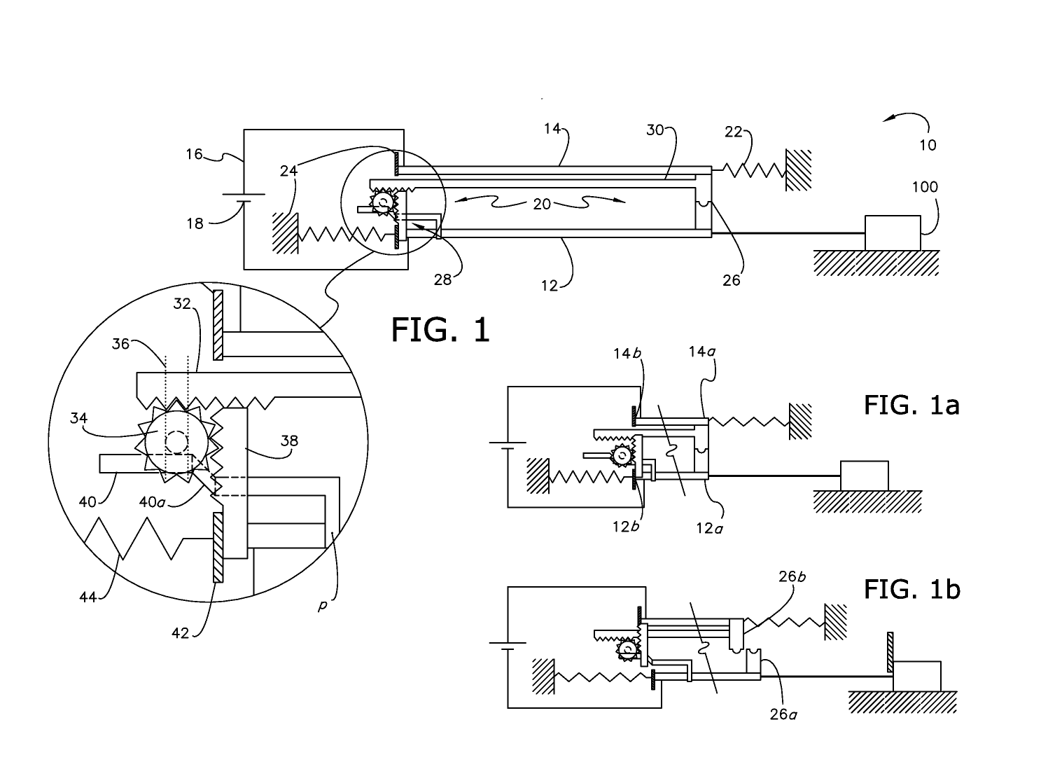

The actuator 12 and switching element 14 are cooperatively configured such that the two are congruently activated; that is to say, the actuator 12 and element 14 are generally contemporaneously and coextensively activated so as to produce generally concurrent and equivalent strokes, wherein the term “generally” shall be specified by the operable range of parameters in the system 10. For example, if the system 10 is configured so as to be operable where the transformation start time and strokes of the actuator 12 and switching element 14 differ by not more than 0.1 sec or 0.1 mm respectively, the term “generally” shall encompass timing and stroke variations less than or equal to 0.1 sec and 0.1 mm. The switching element 14 and actuator 12 may be redundant, where the switching element 14 is not used to provide useful mechanical work during normal operation, or may be cooperatively configured to do the work. As used herein the term “wire” is not used in a limiting sense, and shall include other similar geometric configurations presenting tensile load strength/strain capabilities, such as cables, bundles, braids, ropes, strips, chains, etc., and may include differing pluralities of the same. Various embodiments of the system 10 are shown in FIGS. 1-5.

### I. Exemplary Active Material Morphology and Function

As used herein the term “active material” is defined as any material or composite that exhibits a reversible change in fundamental (i.e., chemical or intrinsic physical) property when exposed to or precluded from an activation signal. Suitable active materials for use with examples of the present disclosure include but are not limited to shape memory materials that have the ability to remember at least one attribute such as shape, which can subsequently be recalled by applying an external stimulus. As such, deformation from the original shape is a temporary condition. In this manner, shape memory materials can change to the trained shape in response to an activation signal, thereby producing a stroke. Exemplary shape memory materials include the afore-mentioned shape memory alloys (SMA) and shape memory polymers (SMP), as well as shape memory ceramics, electroactive polymers (EAP), ferromagnetic SMA's, electrorheological (ER) compositions, high-volume paraffin wax, magnetorheological (MR) compositions, dielectric elastomers, ionic polymer metal composites (IPMC), piezoelectric composites, various combinations of the foregoing materials, and the like.

Shape memory alloys (SMA's) generally refer to a group of metallic materials that demonstrate the ability to return to some previously defined shape or size when subjected to an appropriate thermal stimulus. Shape memory alloys are capable of undergoing phase transitions in which their yield strength, stiffness, dimension and/or shape are altered as a function of temperature. Generally, in the low temperature, or Martensite phase, shape memory alloys can be pseudo-plastically deformed and upon exposure to some higher temperature will transform to an Austenite phase, or parent phase, and return, if not under stress, to their shape prior to the deformation.

Shape memory alloys exist in several different temperature-dependent phases. The most commonly utilized of these phases are the Martensite and Austenite phases. In the following discussion, the Martensite phase generally refers to the more deformable, lower temperature phase whereas the Austenite phase generally refers to the more rigid, higher temperature phase. When the shape memory alloy is in the Martensite phase and is heated, it begins to change into the Austenite phase. The temperature at which this phenomenon starts is often referred to as Austenite start temperature (Aₛ). The temperature at which this phenomenon is complete is called the Austenite finish temperature (A_{f}).

When the shape memory alloy is in the Austenite phase and is cooled, it begins to change into the Martensite phase, and the temperature at which this phenomenon starts is referred to as the Martensite start temperature (Mₛ). The temperature at which Austenite finishes transforming to Martensite is called the Martensite finish temperature (M_{f}). Thus, a suitable activation signal for use with shape memory alloys is a thermal activation signal having a magnitude sufficient to cause transformations between the Martensite and Austenite phases.

Shape memory alloys can exhibit a one-way shape memory effect, an intrinsic two-way effect, or an extrinsic two-way shape memory effect depending on the alloy composition and processing history. Annealed shape memory alloys typically only exhibit the one-way shape memory effect. Sufficient heating subsequent to low-temperature deformation of the shape memory material will induce the Martensite to Austenite phase transformation, and the material will recover the original, annealed shape. Hence, one-way shape memory effects are only observed upon heating. Active materials including shape memory alloy compositions that exhibit one-way memory effects do not automatically cycle with temperature changes back and forth between two shapes, and require an external mechanical force to deform the shape away from its memorized or taught geometry.

Intrinsic and extrinsic two-way shape memory materials are characterized by a shape transition both upon heating from the Martensite phase to the Austenite phase, as well as an additional shape transition upon cooling from the Austenite phase back to the Martensite phase. Active materials that exhibit an intrinsic shape memory effect are fabricated from a shape memory alloy composition that will cause the active materials to automatically reform themselves as a result of the above noted phase transformations. Intrinsic two-way shape memory behavior must be induced in the shape memory material through processing. Such procedures include extreme deformation of the material while in the Martensite phase, heating-cooling under constraint or load, or surface modification such as laser annealing, polishing, or shot-peening. Once the material has been trained to exhibit the two-way shape memory effect, the shape change between the low and high temperature states is generally reversible and persists through a high number of thermal cycles. In contrast, active materials that exhibit the extrinsic two-way shape memory effect are composite or multi-component materials. They combine an alloy that exhibits a one-way effect with another element that provides a restoring force to reform the original shape.

The temperature at which the shape memory alloy remembers its high temperature form when heated can be adjusted by slight changes in the composition of the alloy and through heat treatment. In nickel-titanium shape memory alloys, for instance, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the system with shape memory effects, superelastic effects, and high damping capacity.

Suitable shape memory alloy materials include, without limitation, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Thus, for the purposes of this present disclosure, it is appreciated that SMA's exhibit a modulus increase of approximately 2.5 times and a dimensional change of up to 8% (depending on the amount of pre-strain) when heated above their phase transition temperature. It is appreciated that where the SMA is one-way in operation, a biasing force return mechanism (such as a spring) would be required to return the SMA to its starting configuration. Finally, it is appreciated that Joule heating can be used to make the entire system electronically controllable.

In the Austenite phase, stress induced phase changes in SMA exhibits a superelastic (or pseudoelastic) behavior that refers to the ability of SMA to return to its original shape upon unloading after a substantial deformation in a two-way manner. That is to say, application of increasing stress when SMA is in its Austenitic phase will cause the SMA to exhibit elastic Austenitic behavior until a certain point where it is caused to change to its lower modulus Martensitic phase where it can exhibit up to 8% of superelastic deformation. Removal of the applied stress will cause the SMA to switch back to its Austenitic phase in so doing recovering its starting shape and higher modulus, as well as dissipating energy under the hysteretic loading/unloading stress-strain loop. Moreover, the application of an externally applied stress causes the Martensite phase to form at temperatures higher than Mₛ. Superelastic SMA can be strained several times more than ordinary metal alloys without being plastically deformed; however, this is only observed over a specific temperature range, with the largest ability to recover occurring close to A_{f}.

### II. Examples, Applications, and Uses

Returning to the structural configuration of the present disclosure, FIG. 1 shows an overloading protection system 10 forming a circuit 16. The circuit 16 includes an electric power source (e.g., vehicular charging system, battery, etc.) 18, and a shape memory alloy actuator wire 12 presenting working and stationary ends 12a,b, drivenly coupled to a load 100, and producing a driving force when activated by the power source 18. The circuit 16 further includes a switching SMA wire 14 electrically coupled in series to the actuator wire 12, a releasable connector 20 inter-engaging the actuator 12 and switching wire 14, and preferably a return spring (or otherwise biasing element) 22 drivenly coupled to the connector 20. It is appreciated that the connector 20 presents an electrical switch that can be implemented in a variety of ways known in the art and aimed at providing the capability to open and close electrical circuit 16 in response to relative action between the actuator 12 and switching element 14. The several components described herein may be integral or variably combined, and interconnection between adjacent parts is performed using suitable methods, such as bonding, welding, etc.

More particularly, in FIGS. 1, 1a and 1b, the preferred actuator wire 12 is connected, directly or indirectly, to fixed structure 24 at one end and to the load 100 at the other end; though bowstring and other configurations may be employed. The switching SMA wire 14 is connected to fixed structure 24 at its stationary end 14b and to the connector 20 at its working end 14a (FIG. 1a). The return spring 22 is also anchored to fixed structure 24, and works to bias the connector 24 towards its engaged or home position. The power source 18 is connected to the wires 12,14, configured to feed the circuit 16 from one terminal, through the switching wire 14, through the connector 20, through the actuator wire 12, and eventually to the other terminal of the source 18. When the temperatures of the wires 12,14 are below their transformation temperature ranges, both are in the Martensite phase, the load 100 is not moved and the return spring 22 and switching wire 14 maintain electrical connectivity with the actuator wire 12 through the connector 20. As electrical power is supplied to the system 10, the wires 12,14 are heated resistively through “Joule heating.” When the temperature of the wires 12,14 exceed the transformation temperature range for the wires 12,14 both undergo a phase transformation from Martensite to Austenite that cause them to congruently (i.e. generally contemporaneously and coextensively) contract and pull the load 100 (either redundantly or cooperatively).

To effect the intended function of examples of the present disclosure, it is appreciated that the transformation temperature range of the switching SMA wire 14 is generally equal to the transformation temperature range of the actuator wire 12. This may be accomplished by using identical wires 12,14, with respect to constituency and physical configuration/geometry (e.g., the cross-sectional diameter and length of each wire, the number of wires, exterior finishes, etc.), or by employing equivalent combinations of these parameters. During normal operations, when the temperature of the actuator and switching wires 12,14 are higher than their transformation temperature range, the wires 12,14 are configured, such that contraction results in generally no relative displacement. Thus, it is appreciated that activation of the wires 12,14 must necessarily be accomplished in an even and consistent manner that preferably takes into consideration the history of the actuator versus the switching element. As previously mentioned, Joule heating is a preferred method of activation; it is certainly within the ambit of the present disclosure, however, to utilize passive activation where the temperature gradient across the wires 12,14 allows (e.g., the wires are closely packaged).

When the load 100 is blocked, only the switching wire 14 is able to contract, thereby causing the releasable connector 20 to shift to the disengaged position (FIG. 1b). At the working ends 12a,14a, this terminates the activation signal to both wires 12,14, and stores potential energy in the spring 22. It is appreciated that this result is facilitated by the fact that the transformation temperature of SMA increases with stress level, such that when the actuator 12 is subjected to a higher load level than the switching SMA wire 14, the switching wire 14 will transform first and disconnect the circuit 16 before the actuator 12 completes its transformation. Conversely, if the actuator 12 is subjected to a lower stress than the switching wire 14, the actuator 12 will transform to the Austenite phase before the switching wire 14; the system 10 is configured such that the circuit 16 remains connected under this scenario, despite slack being produced in the switching element 14.

Once the wires 12,14 cool to below the transformation temperature, the return spring 22 pulls the switching wire 14 back to its home or deactivated position, so as to re-establish electrical connection (FIG. 1). Alternatively, it is appreciated that the switching wire 14 may exhibit two-way shape memory effect, such that electrical connectivity is autonomously returned when deactivated.

In examples of the present disclosure, overload protection may be accomplished in one of two methods. As shown in FIG. 1, the releasable connector 20 may engage and selectively disconnect the working end 12a of the actuator 12 from the switching element 14 and source 18, or may engage and selectively disconnect the stationary end 12b of the actuator 12 from fixed structure 24 thereby producing a secondary work output path. More preferably, however, a compound connector 20 may be utilized to both occlude the activation signal, so as to terminate transformation, and produce a secondary work output path, so that the transformation that does occur is mitigated (FIGS. 1, 1a and 1b).

In FIG. 1, the releasable connector 20 includes a holding mechanism 26 inter-engaging the working ends 12a,14a of the actuator 12 and element 14, and presenting a release threshold. The illustrated mechanism 26 includes first and second connector parts 26a,b fixedly attached to the actuator 12 and element 14 respectively, and inter-engaged, for example, by a (spring-biased) ball detent seated within an opposite indentation to provide rolling engagement between the parts 26a,b. Though the holding mechanism 26 is shown as a detent, it is certainly within the ambit of the present disclosure to use other suitable mechanisms, such as a clutch, friction collar, snap, Velcro™ strip, etc. The holding mechanism 26 is configured to be overcome by the load 100 only in overloading conditions, and more particularly, where the load 100 exceeds the predetermined threshold (e.g., the maximum driving force of the actuator, the tensile capacity of the wire times a safety factor, etc.). As shown in FIG. 1b, obstructing the load 100 during actuation produces an overload condition, wherein tensile stress builds within the actuator 12. Once shear across the connector 26 overcomes the detent force, relative translation between the wires 12,14 occurs. As a result, the circuit 16 is opened, thereby discontinuing the activation signal to the actuator 12.

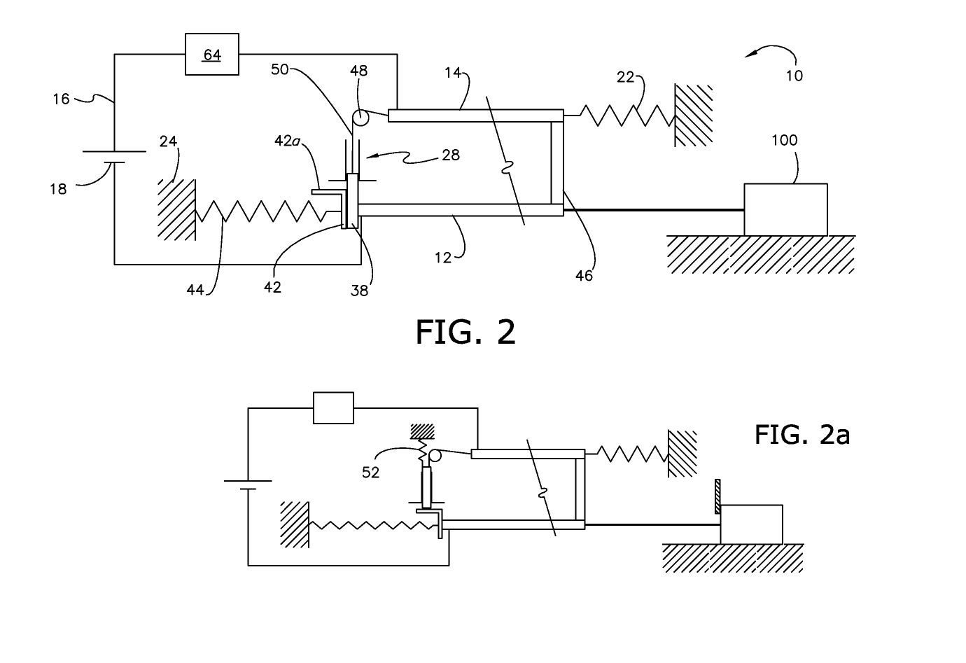

Also shown in FIGS. 1, 1a and 1b, the preferred releasable connector 20 further includes a latching assembly 28 operable to selectively free the stationary end 12b of the actuator 12, so as to produce a secondary work output path. As an example, the assembly 28 presents a rack-and-pinion assembly, though it is appreciated that various other latching arrangements, including the ones shown in FIGS. 2-4 may be used. More particularly, in FIG. 1, the second part 26b of the holding mechanism 26 presents an elongated arm 30 having a distally defined horizontal rack 32, wherein the “horizontal” direction coincides with the longitudinal axis of the actuator 12. The rack 32 engages the top half of a pinion 34 that floats within a vertical slot 36. A vertical rack/blocking member 38 engages the right half of the pinion 34, so as to be driven between distended engaged and lifted disengaged positions. The pinion 34 is supported by a ledge 40 fixedly attached to a point, p, on the actuator 12. The ledge 40 slidingly engages the pinion 34 such that relative motion therebetween does not effect rotation by the pinion 34. The upper rack 32, ledge 40, and slot 36 cause the pivot axis of the pinion 34 to be fixed in space; and as a result, the pinion 34 to drive the vertical rack/blocking member 38 when driven by the upper rack 32. The vertical rack/blocking member 38 abuts an end cap 42 fixedly attached to the stationary end 12b of the actuator 12, so as to fix the end 12b, when in a distended-engaged position. The ledge 40 includes a ramp down 40a towards the interior of the actuator 12.

In operation, the ledge 40 and ramp 40a are caused to translate as the actuator 12 contracts. The point p is selected such that the available stroke at p is sufficient for the ledge 40 and ramp 40a to clear the pinion 34. Once the pinion 34 is cleared, the pinion 34 is caused to drop away from and disengage the horizontal rack 32, due to gravity or other biasing force (housed within the slot 36, for example). In the disengaged condition, the vertical rack/blocking member 38 is no longer driven and remains in an abutting position relative to the end cap 42. Thus, when the actuator and switching wires 12,14 are both caused to contract (i.e., an overloading condition does not occur), the rack/member 38 will briefly rise but not clear the cap 42, thereby maintaining a fixed stationary end 12b.

Where an overload condition does occur, such that the point p is not allowed to undergo its stroke, the pinion 34 remains in communication with the horizontal rack 32 and drivenly coupled to the vertical rack/blocking member 38 for the entirety of the switching wire's stroke. This results in the rack/member 38 being driven upward until clearing the cap 42. Once cleared, the end cap 42 and the “stationary” end 12b becomes free to horizontally translate. In an example, an actuator return spring 44 is drivenly coupled to the cap 42 antagonistic to the driving force of the actuator 12, so as to bias the stationary end 12b towards its home position. Because the spring 44 does not have to function as a relief spring (i.e., does not have to withstand normal operating drive forces), it may be substantially reduced in size. Thus, relative motion between the working ends 12a,14a of the actuator and switching wires 12,14 both terminates the activation signal and creates a secondary work output path at the stationary end 12b of the actuator 12.

In FIGS. 2 and 2a, an alternative embodiment of a latching assembly 28 is shown. In this configuration, the latching assembly 28 is driven by the stationary end 14b of the switching element (e.g., SMA wire) 14 though it is appreciated that modification to drive the assembly 28 from the working end 14a may be readily made. In FIG. 2, a common member 46 structurally interconnects the actuator 12 and switching wire 14 at their working ends 12a,14a, so that relative displacement can only occur at the stationary ends 12b,14b. The latching assembly 28 includes a vertically oriented blocking member 38 (e.g., a metal pin, wedge, planar sheet, etc.) that translates between distended engaged and lifted disengaged positions. In the distended position, the blocking member 38 is configured to abut an end cap 42 fixedly attached to the stationary end 12b of the actuator 12, and an actuator return spring 44 intermediate the cap 42 and fixed structure 24 is again provided to bias the end 12b towards its home position. The preferred end cap 42 includes a horizontal support section 42a that prevents the blocking member 38 from distending during the secondary work output, even where the switching element 14 has been deactivated. The horizontal support section 42a is, therefore, cooperatively configured with the actuator stroke. A pulley 48 functions to redirect the drive force produced by the switching wire 14 from horizontal to vertical; and finally, a durable link 50, entrained by the pulley, interconnects the blocking member 38 and switching wire 14. Preferably, a latch return spring 52 may be included to exert a biasing force upon the blocking member 38 towards the engaged position (FIG. 2a). It is appreciated that the drive force generated by the switching element 14 is greater than the opposing force produced by the biasing spring 52 and the weight of the blocking member 38.

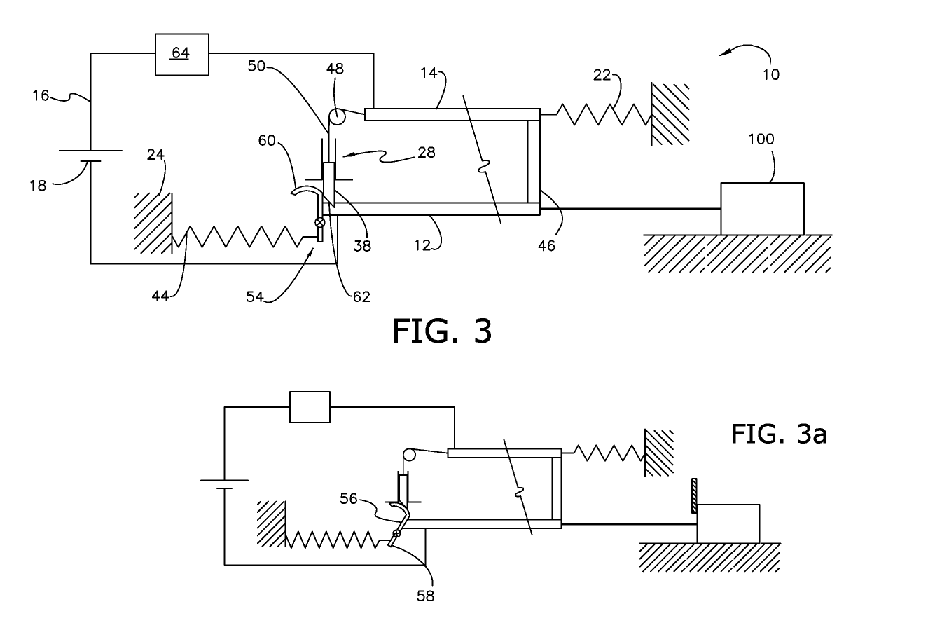

In FIG. 3, another example of a latching assembly 28 is shown. In this configuration, the assembly 28 features a pivotal lever 54 attached to the stationary end 12b of the actuator 12 in lieu of the end cap 42. The lever 54 defines a pivot axis and includes actuator and return engaging arms 56,58 (FIG. 3a). Based on the relative lengths of the arms 56,58, and more particularly, the distances between the connection points of the actuator 12 and actuator return spring 44 and the axis, it is appreciated that the lever 54 may provide mechanical advantage. The blocking member 38 is drivenly coupled to the stationary end 14b of the switching wire 14 as described above, so as to be caused to translate where relative displacement between the wires 12,14 occurs. An arcuate interface 60 is preferably attached to the lever 54 at the distal end of the actuator arm 56 to enable and maintain constant engagement with the blocking member 38 as the lever 54 swings. More preferably, and as shown in FIG. 3a, the blocking member 38 defines a sloped interface 62. The sloped interface 62 enables quicker and more gradual secondary work output by the actuator 12, in that the blocking member 38 does not have to be completely cleared prior to the start of motion. Moreover, the sloped interface 62 also results in a more responsive system 10 as both the actuator 12 and switching element 14 work to release the latch 28 once the interface 62 is acted upon by the actuator 12. Finally, a common member 46 is again provided to fixedly interconnect the actuator 12 and switching element 14 at their working ends 12a,14a, so that relative displacement occurs at their stationary ends 12b,14b.

As shown in FIGS. 2, 2a, 3 and 3a, a controller 64 may be included within the circuit 16 to control the manner (e.g., rate, timing, etc.) in which the actuator 12 and switching element 14 are activated. In those examples, however, the controller 64 does not receive feedback from the connector 24, which opens and closes the circuit 16 in direct response to mechanical force supplied by the overloading condition and return spring 22.

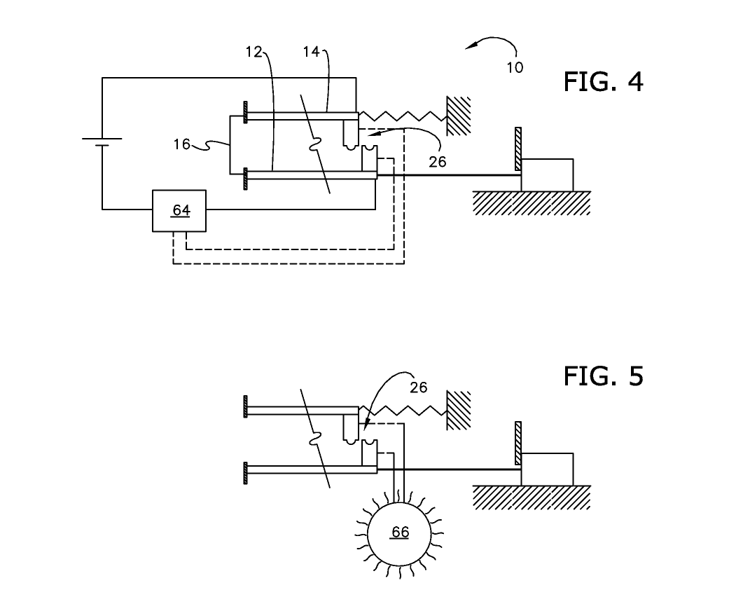

In FIG. 4, an example of the present disclosure is shown wherein the controller 64 does receive feedback from the holding mechanism 26. In this configuration, the circuit 16 excludes the mechanism 26 and is, therefore, not interrupted when the mechanism 26 is overcome. Instead, the mechanism 26 is communicatively (e.g., via hardwire or wireless communication) coupled to the controller 64 and informs the controller 64 when it is released (i.e., a triggering overload event has occurred). The controller 64, in turn, performs an action or produces an output upon receipt of the information, such as, for example, discontinuing the activation signal after confirming the overloading condition. Where brief overloading conditions commonly occur, the preferred controller 64 may be configured to wait a predetermined cooling period, wherein the mechanism 26 is reset by its return spring 22, before trying to actuate again.

In yet another embodiment, the connector 24, and not the actuator 12 nor element 14, composes a peripheral circuit 66 that passively activates the actuator 12 and element 14 (FIG. 5). Here, again, the connector 24 may directly open and close the peripheral circuit or may offer feedback to a controller composing the same. It is appreciated that in all the illustrated embodiments, although the actuator and switching wires 12,14 are shown as a single wire, they may each include multiple wires arranged in various configurations, including parallel arrangements or rope/cable. Further, the illustrations should not be interpreted as implying that the actuating and switching wires are of equal amount.

As used herein, the terms “first”, “second”, and the like do not denote any order or importance, but rather are used to distinguish one element from another.

In describing and claiming the examples disclosed herein, the singular forms “a”, “an”, and “the” include plural referents unless the context clearly dictates otherwise.

It is to be understood that the ranges provided herein include the stated range and any value or sub-range within the stated range. For example, a range from about 100° C. to below about −100° C. should be interpreted to include not only the explicitly recited limits of about 100° C. to below about −100° C., but also to include individual values, such as −50° C., 30° C., etc., and sub-ranges, such as from about 75° C. to about −25° C., etc. Furthermore, when “about” is utilized to describe a value, this is meant to encompass minor variations (up to +/−10%) from the stated value.

While several examples have been described in detail, it will be apparent to those skilled in the art that the disclosed examples may be modified. Therefore, the foregoing description is to be considered non-limiting.

1. An overloading protection system adapted for use with a shape memory alloy actuator, wherein the actuator is communicatively coupled to an activation source, drivenly coupled to a load, produces a driving force when activated by the source, and presents stationary and working ends, the system comprising:
a shape memory alloy element communicatively coupled to the source and cooperatively configured with the actuator, such that the actuator and element are generally contemporaneously and coextensively activated; and
a releasable connector interconnecting the actuator and element;
wherein the actuator, element, and connector are cooperatively configured to drive the load when the load is less than a threshold and the actuator and element are activated, and disconnect the actuator and element when the load is equal to or greater than the threshold and the actuator and element are activated.

2. The system as defined in claim 1 wherein the connector is further to de-couple the actuator and source, when the load is equal to or greater than the threshold and the actuator and element are activated.

3. The system as defined in claim 1 wherein the actuator and element are connected in series and activated through Joule heating, and the actuator, element, connector, and source compose an electric circuit.

4. The system as defined in claim 1 wherein the actuator and element present equivalent combinations of constituencies and geometric configurations, so as to present congruent transformation temperature ranges.

5. The system as defined in claim 1 wherein the connector includes a hold mechanism inter-engaging the working end of the actuator and the element, and configured to be overcome by the load when the load is equal to or greater than the threshold.

6. The system as defined in claim 5 wherein the hold mechanism includes a detent.

7. The system as defined in claim 1 wherein the connector and not the actuator or element composes a circuit, the connector is configured to selectively open and close the circuit, and the actuator and element are passively activated by the circuit when closed.

8. The system as defined in claim 1 wherein the actuator, element, and source and not the connector composes a circuit, the circuit further includes a controller configured to selectively cause the source to activate the actuator, and the connector is communicatively coupled to the controller, so as to offer feedback to the controller and in turn cause the source to activate the actuator.

9. The system as defined in claim 1, further comprising a return spring drivenly coupled to the element, and operable to reconnect the actuator and element when the element is deactivated.

10. The system as defined in claim 1 wherein the connector includes a latch inter-engaging the stationary end of the actuator and element, shiftable between engaged and disengaged conditions, and configured to shift to the disengaged position when the load is equal to or greater than the threshold, and the stationary end of the actuator is fixed when the latch is in the engaged position and free to translate when the latch is in the disengaged position.

11. The system as defined in claim 10 wherein the latch includes a rack and pinion assembly.

12. The system as defined in claim 10, further comprising a common member fixedly interconnecting the actuator and element at the working end.

13. The system as defined in claim 10 wherein the latch includes a blocking member drivenly coupled to the element, and a pivotal lever presenting actuator and return engaging arms, fixed to the stationary end of the actuator at the actuator engaging arm and configured to abut the member when the latch is in the engaged condition.

14. The system as defined in claim 13, further comprising an actuator return spring drivenly coupled to the lever antagonistic to the driving force, such that the return spring is caused to store energy when the stationary end is caused to translate by the actuator, and connected to the return engaging arm, such that the lever provides mechanical advantage.

15. The system as defined in claim 10 wherein the latch includes a blocking member drivenly coupled to the element, and an end cap fixed to the stationary end of the actuator and configured to abut the member when the latch is in the engaged condition, and the end cap includes a horizontal support section configured to retain the member in the disengaged condition.

16. The system as defined in claim 15 wherein the blocking member presents a sloped interface, and the interface engages the end cap when the latch is in the engaged condition so as to provide gradual disengagement.

17. The system as defined in claim 15 wherein the member is caused to translate between first and second positions defining the engaged and disengaged conditions respectively when the load is equal to or greater than the threshold and the actuator and element are activated, and the blocking member is biased towards the second position.

18. The system as defined in claim 17 wherein the latch further includes a compression spring drivenly coupled to the member antagonistic to the element.

19. The system as defined in claim 15, further comprising a return spring drivenly coupled to the end cap antagonistic to the driving force, wherein the return spring is caused to store energy when the stationary end is caused to translate.

20. The system as defined in claim 1 wherein the connector includes:
a hold mechanism inter-engaging the working end of the actuator and the element, and configured to be overcome by the load when the load is equal to or greater than the threshold; and
a latch inter-engaging the stationary end of the actuator and the element, shiftable between engaged and disengaged conditions, and configured to be overcome by the load when the load is equal to or greater than the threshold so as to be caused to shift to the disengaged position, and the stationary end of the actuator is fixed when the latch is in the engaged position and free to translate when the latch is in the disengaged position.
